(19) United States
(12) Patent Application Publication
(10) Pub. No.: US 2006/0196601 A1
(43) Pub. Date: Sep. 7, 2006

(54) Manufacturing Method of Laminated Card, Laminating Apparatus and Card Printing Apparatus Thereof

(75) Inventors: Toshinori Takahashi, Nakahara-ku, Kawasaki-shi (JP); Tomonori Sumida, Yamato-shi, (JP)

Correspondence Address: CONNOLLY BOVE LODGE & HUTZ LLP, SUITE 800, 1990 M STREET NW, WASHINGTON, DC, 20036-3425, US

(73) Assignee: VICTOR COMPANY OF JAPAN, LIMITED, Kanagawa-ku (JP)

(21) Appl. No.: 11/306,837

(22) Filed: Jan. 12, 2006

(30) Foreign Application Priority Data
Feb. 18, 2005 (JP) 2005-041887
Jan. 18, 2005 (JP) 2005-041888
Feb. 18, 2005 (JP) 2005-041886

(51) Int. Cl. B32B 37/08; B32B 38/14

(52) U.S. Cl. 156/277; 156/498; 156/311; 156/387; 156/538

(57) ABSTRACT

A laminating apparatus 100 is composed of a cooling section 120 for cooling a card 1, and a thermo compression bonding section LR for thermally compression bonding the card 1 cooled by the cooling section 120 and a laminate film 2 having a material for forming a protective film 2a so as to produce a laminated card by bonding the material for forming a protective film 2a on at least one surface 1 a of the card 1.

### BACKGROUND OF THE INVENTION

1. Field of the Invention

The present invention relates to a manufacturing method of a laminated card of which surface is laminated with a protective film, a laminating apparatus for laminating a protective film on a surface of a card and a card printing apparatus, which prints information on a surface of a card and then conducts a laminating process thereon.

2. Description of the Related Art

As a full-blown card era has come, various kinds of cards have normally been used in daily life. Such a card is, for example, a card of which surface is printed with specific information, a magnetic card such as a telephone card, and an IC card in which an IC memory chip is installed as represented by a credit card. In case of applications for identifying a person, an image such as a facial portrait of the person is printed on a surface of a card.

It is often the case that those various kinds of cards are laminated with a protective film on their surfaces so as to protect their surfaces from scratching or stain, or so as to prevent information printed thereon from being altered.

More specifically, by thermally compression bonding a transparent film in ribbon shape having a thickness of approximately 10 μm to 30 μm on a surface of a card, which was previously printed with information, the transparent film is bonded on the surface of the card and results in a protective film.

A laminating apparatus for conducting the laminating process is disclosed in the Japanese publication of unexamined patent applications No. 2004-155153.

The laminating apparatus disclosed in the Japanese publication of unexamined patent applications No. 2004-155153 laminates a protective body (laminate film), which is formed with a resin layer to be a protective layer on a substrate such as PET (polyethylene terephthalate), on a surface of a recording medium such as a card, which is made from plastic or woodfree paper through a thermo compression bonding process by means of a heat roller, and resulting in laminating the resin layer on the surface of the card.

In the manufacturing process of such a laminated card mentioned above, there existed a problem, which was caused by heat applied to a card and a laminate film during the laminating process.

More accurately, it is necessary for a substrate of the laminate film to be peeled off after the laminating process. During the peeling off process, if temperature of the laminate film was higher than the normal condition, adhesive strength between the substrate and the resin layer was excessively strong. Consequently, the substrate was hardly peeled off from the substrate, and resulted in a problem of defective peeling-off.

In order to solve the above-mentioned problem, the Japanese publication of unexamined patent applications No. 2004-155153 disclosed the laminating apparatus provided with the cooling fan, which was installed in the downstream side of the thermo compression bonding roller on the transporting route of a recording medium (card) to be laminated with the protective body (laminate film). The card and the laminate film were cooled down by wind from the cooling fan after they were laminated together.

On the other hand, with respect to the other methods of laminating, there existed a method such that a substrate of a laminate film itself was bonded on a surface of a card, and the substrate resulted in a protective film.

In this case, the laminate film is constituted by a substrate and an adhesive layer, and the substrate is previously cut halfway along a border line of an area to be bonded, that is, contour of a card normally.

Then, after the laminating process is conducted, a part of the laminate film, which is not bonded on a card, is separated from the laminate film such that the part is cut off along the halfway cut portion.

In this particular case, if temperature of the laminate film was higher than the normal condition during the separating process, it was not easy to cut the laminate film along the halfway cut portion because the laminate film was softened by the higher temperature. Consequently, there existed some possibility of occurring a problem of defective separation. However, by cooling down the laminate film after the laminating process, such a problem of defective separation enables to be prevented.

In this connection, another problem during the laminating process is warpage of a card in general.

More specifically, in the peeling off process or the separating process according to the above-mentioned two methods of laminating, force in the direction of peeling the laminate film is applied to the card in any case. If temperature of the card was higher than the normal condition, there existed a problem such that the force easily deformed the card, and the card was resulted in defective.

With respect to the particular problem, according to the laminating apparatus disclosed in the Japanese publication of unexamined patent applications No. 2004-155153, the card is cooled down by wind from the cooling fan after the laminating process is conducted. Consequently, it is expected for the card to be prevented from occurrence of warpage caused by peeling off.

By the way, a laminating process is generally a final stage of a manufacturing process of a card. Consequently, temperature of a card to be supplied for laminating is directly affected by the card temperature in a preceding process prior to the laminating process and a time interval between the laminating process and the preceding process.

In case the preceding process is a printing process for printing information on a surface of a card, for example, a card is manufactured by shortening the time interval between processes such that an outlet of a printing device for carrying out a printed card is directly connected to a carrying-in entrance of a laminating device for the printed card so as to improve a manufacturing efficiency.

Further, in case a card printing apparatus is equipped with a laminating function, such a card printing apparatus is constituted by furnishing a printing mechanism and a laminating mechanism corresponding to a laminating device, which are directly connected therein, and the laminating process is conducted immediately after the printing process.

In the process of printing information on a surface of a card, a printing method such as the thermal transfer printing method has been well known as the printing method of heating a card.

In case of the thermal transfer printing method, for example, a card itself is heated by a heat transfer roller, and temperature of the card is raised up to high temperature of 40° C. to 50° C. much higher than the normal temperature.

In case the laminating process is conducted to a card immediately after the printing process, the card of which temperature is not cooled down as low as the normal temperature is supplied to the laminating device and further added with extra heat for laminating therein.

Accordingly, the card mentioned above is conducted through the laminating process with having higher temperature much higher than the normal temperature, and resulting in a problem such that the card is extremely deformed.

Further, in case a heating element such as a power source and a heater is provided nearby a card stocking section or a card carrying route inside a printing device although the printing device does not heat a card when printing, card temperature is raised higher by heat generated by the heating element, and possibly resulting in the similar problem as mentioned above.

As mentioned above, temperature of a card to be supplied to the laminating process is raised higher than the normal temperature and degree of high temperature varies depending on installation conditions of a laminating device.

In case card temperature scattered in a high temperature region during the laminating process, peeling strength or softening degree of a film was resulted in making a difference during the peeling off process or the separating process of the laminate film after the laminating process. Consequently, defective peeling or defective separation possibly occurred.

Further, adhesion strength of the laminate film after the laminating process also scattered, and possibly resulted in further problem such that the protective film peeled off by itself with time.

In order to avoid the above-mentioned problems caused by heat, there exists a method of using a card having heat resistance for high temperature. However, such a card generates a further problem of increasing material cost extremely.

### SUMMARY OF THE INVENTION

Accordingly, in consideration of the above-mentioned problems of the prior art, an object of the present invention is to provide a manufacturing method of a laminated card, a laminating apparatus and a card printing apparatus, which enable to decrease defects that occur during a peeling off process of a laminate film. Another object of the present invention is to provide a manufacturing method of a laminated card, a laminating apparatus and a card printing apparatus, which enable to decrease warpage of a card or variation per hour after the laminating process. Further object of the present invention is to provide a manufacturing method of a laminated card, a laminating apparatus and a card printing apparatus, which enable to manufacture a laminated card in lower cost and higher quality.

According to an aspect of the present invention, there provided a manufacturing method of a laminated card comprising the steps of: cooling for cooling a card; and thermo compression bonding for thermally compression bonding the card cooled through the step of cooling and a laminate film having a material for forming a protective film so as to produce a laminated card by bonding the material for forming a protective film on at least one surface of the card.

According to another aspect of the present invention, there provided a laminating apparatus for manufacturing a laminated card comprising: a cooling section for cooling a card; and a thermo compression bonding section for thermally compression bonding the card cooled in the cooling section and a laminate film having a material for forming a protective film so as to produce a laminated card by bonding the material for forming a protective film on at least one surface of the card.

According to a further aspect of the present invention, there provided a card printing apparatus comprising: a printing section for printing information on at least one surface of a card; a cooling section for cooling the card printed by the printing section; and a thermo compression bonding section for thermally compression bonding the card cooled by the cooling section and a laminate film having a material for forming a protective film so as to produce a laminated card by bonding the material for forming a protective film on the one surface of the card.

Other object and further features of the present invention will be apparent from the following detailed description when read in conjunction with the accompanying drawings.

### BRIEF DESCRIPTION OF THE DRAWINGS

FIG. 1 is a plan view of a laminating apparatus according to a first embodiment of the present invention showing an internal constitution.

FIG. 2 is a plan view of a driving mechanism adopted in a laminating apparatus and a laminating section according to each embodiment of the present invention.

FIG. 3 is a block diagram of the laminating apparatus and the laminating section according to each embodiment of the present invention.

FIG. 4 is a timing chart of the laminating apparatus shown in FIG. 1 according to the first embodiment of the present invention.

FIG. 5(a) is a plan view showing a frame format of a major part of the laminating apparatus shown in FIG. 1 according to the first embodiment of the present invention.

FIG. 5(b) is a plan view of a laminate film viewed from an arrow “A” direction in FIG. 5(a).

FIG. 6 is a plan view of a card carrying-out section of the laminating apparatus and the laminating section according to each embodiment of the present invention.

FIG. 7 is a plan view showing a frame format of a card printing apparatus according to a second embodiment of the present invention.

FIG. 8 is a plan view of a laminating apparatus according to a third embodiment of the present invention showing an internal constitution.

FIG. 9 is a timing chart of the laminating apparatus shown in FIG. 8 according to the third embodiment of the present invention.

FIG. 10(a) is a plan view showing a frame format of a major part of the laminating apparatus shown in FIG. 8 according to the third embodiment of the present invention.

FIG. 10(b) is a plan view of a laminate film viewed from an arrow “A” direction in FIG. 10(a).

FIG. 11 is a plan view showing a frame format of a card printing apparatus according to a fourth embodiment of the present invention.

### DETAILED DESCRIPTION OF THE PREFERRED EMBODIMENTS

Prior to describing each embodiment in detail, some definitions common to each embodiment shall be described as a matter of first priority.

With respect to a direction of a card to be carried, a direction toward a card carrying-out slot and another direction toward a card intake slot are defined as a forward direction and a backward direction respectively. It is understood that the backward direction is an opposite direction to the forward direction.

### First Embodiment

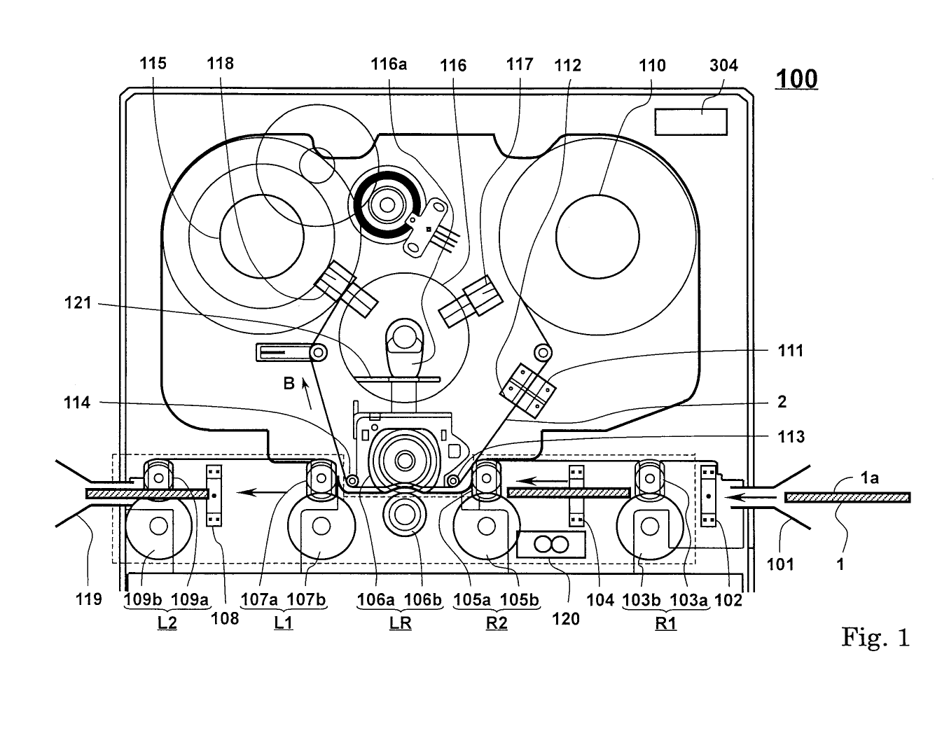

FIG. 1 is a plan view of a laminating apparatus according to a first embodiment of the present invention showing an internal constitution.

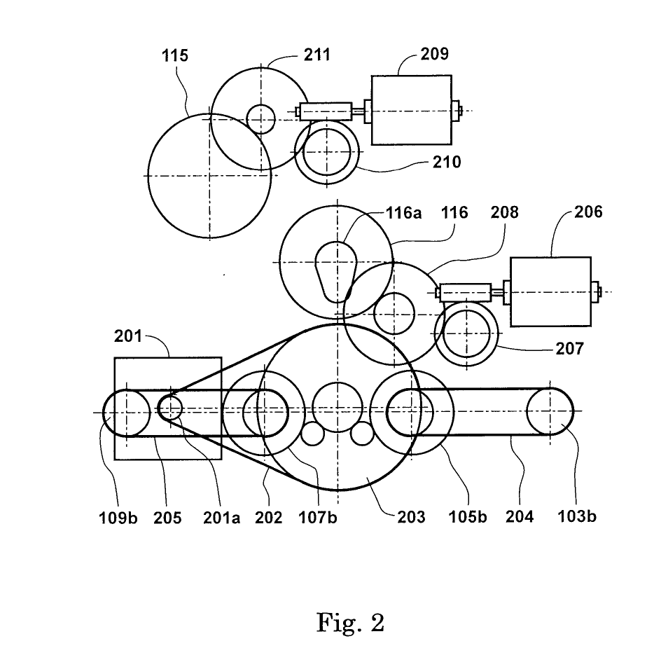

FIG. 2 is a plan view of a driving mechanism adopted in a laminating apparatus and a laminating section according to each embodiment of the present invention.

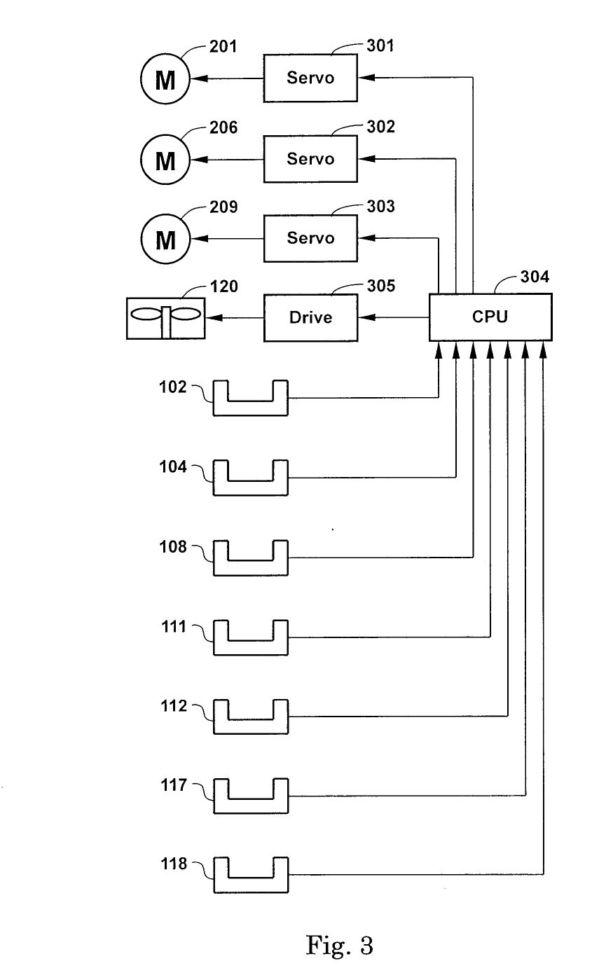

FIG. 3 is a block diagram of the laminating apparatus and the laminating section according to each embodiment of the present invention.

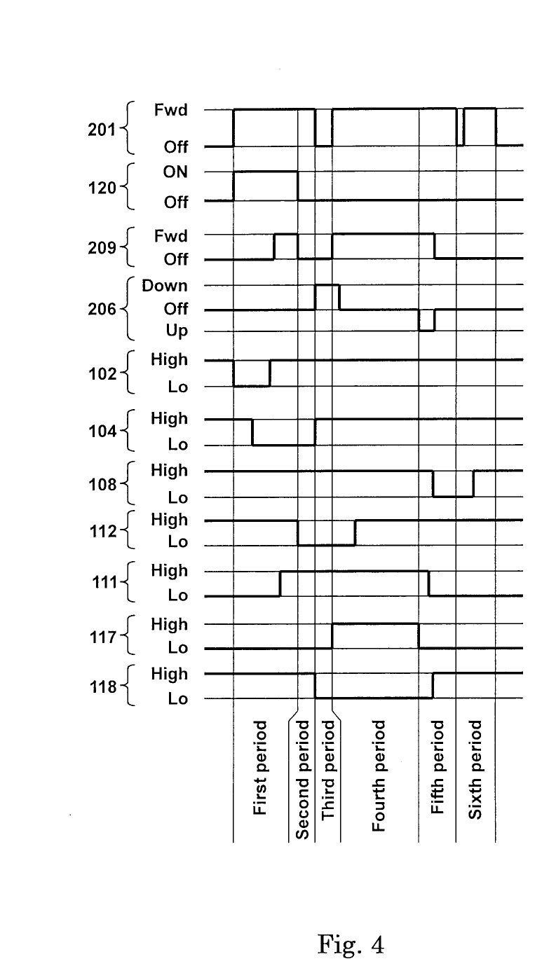

FIG. 4 is a timing chart of the laminating apparatus shown in FIG. 1 according to the first embodiment of the present invention.

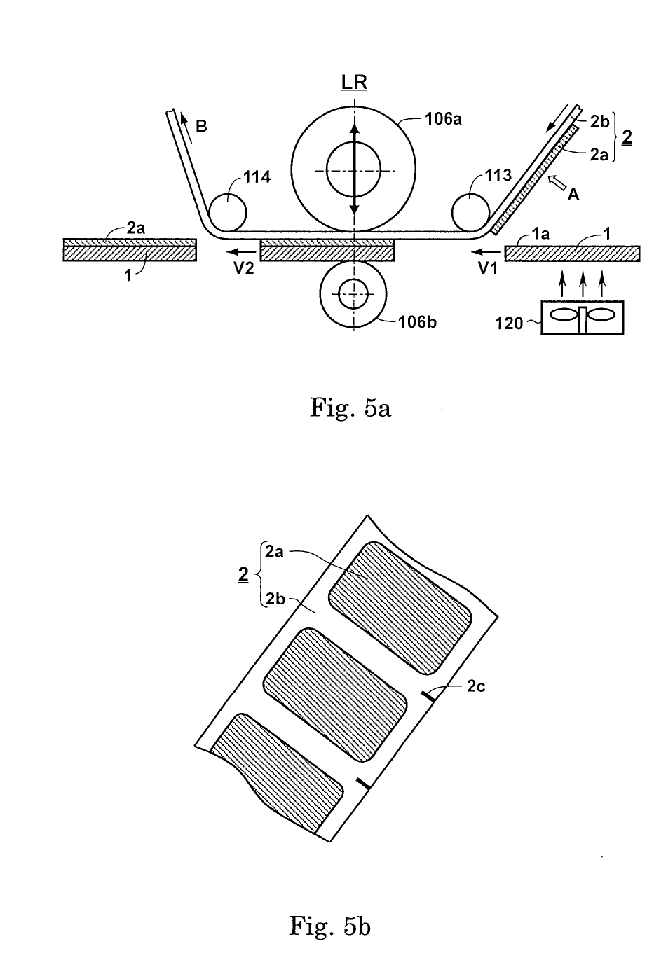

FIG. 5(a) is a plan view showing a frame format of a major part of the laminating apparatus shown in FIG. 1 according to the first embodiment of the present invention.

FIG. 5(b) is a plan view of a laminate film viewed from an arrow “A” direction in FIG. 5(a).

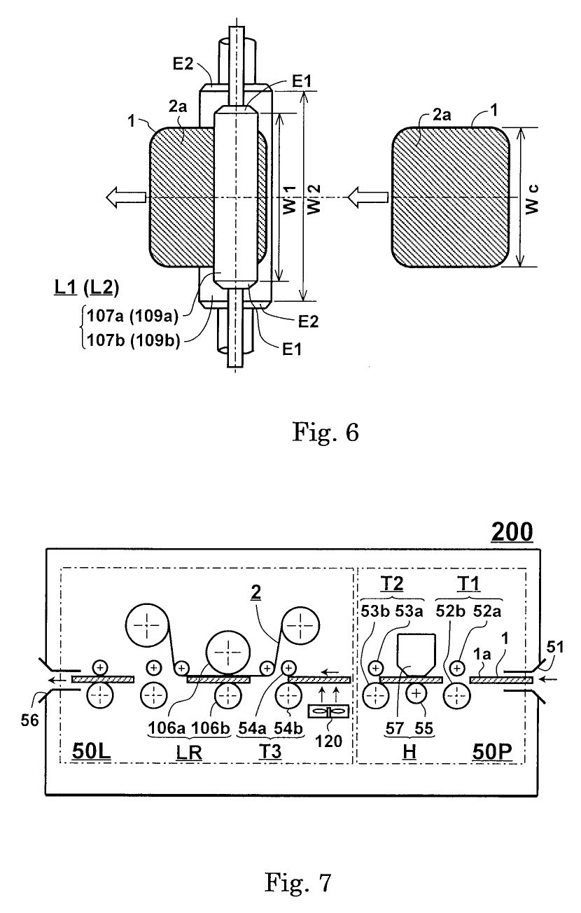

FIG. 6 is a plan view of a card carrying-out section of the laminating apparatus and the laminating section according to each embodiment of the present invention.

With referring to FIG. 1, a laminating apparatus according to a first embodiment of the present invention is depicted in detail.

In FIG. 1, a laminating apparatus 100 is an apparatus for laminating a protective film on a surface 1a of a card 1, which is previously recorded or printed with information.

More specifically, the laminating apparatus 100 conducts a laminating process on the surface 1a of the card 1, which is inserted into a card intake slot 101, and finally the card 1 that is conducted through the laminating process is carried out from a card carrying-out slot 119.

Further, the card 1 exemplified in the first embodiment is made from PVC (polyvinyl chloride), for example. However, it shall be understood that a material of the card 1 is not limited to PVC.

The laminating apparatus 100 is specifically described in detail next along a carrying route of the card 1 from the card intake slot 101 to the card carrying-out slot 119.

As shown in FIG. 1, the laminating apparatus 100 is composed of the card intake slot 101, a card detecting sensor 102, a first card carrying-in roller section R1 that is constituted by a pair of a press shaft 103a and a card carrying roller 103b, a laminating position sensor 104, a second card carrying-in roller section R2 that is constituted by a pair of a press shaft 105a and a card carrying roller 105b, a laminating roller section LR for thermo compression bonding that is constituted by a pair of heat roller 106a and a heat press shaft 106b, a first card carrying-out roller section L1 that is constituted by a pair of a press shaft 107a and a card carrying roller 107b, a card carrying-out sensor 108, a second card carrying-out roller section L2 that is constituted by a pair of a press shaft 109a and a card carrying roller 109b, the card carrying-out slot 19, and a cooling fan 120. The cooling fan 120 is allocated in an upstream side of the laminating roller section LR nearby the carrying route of the card 1.

Hereupon, the card intake slot 101, the first card carrying-in roller section R1 and the second card carrying-in roller section R2 constitute a card carrying-in route.

Further, the first card carrying-out roller section L1, the second card carrying-out roller section L2 and the card carrying-out slot 119 constitute a card carrying-out route.

Furthermore, the card carrying-in route and the card carrying-out route are generically referred to as a carrying route of the card 1.

In the carrying route of the card 1, the laminating roller section LR conducts a thermo compression bonding process (hereinafter generically referred to as laminating process).

In addition thereto, the laminating apparatus 100 is further composed of a laminate film feeding section (to be detailed later) and a CPU (Central Processing Unit) 304 for controlling the laminating apparatus 100 totally.

With referring to FIG. 6, functions and operations of the press shafts 107a and 109a and the card carrying rollers 107b and 109b, which constitute the first and second card carrying-out roller sections L1 and L2 respectively, are described next.

FIG. 6 is a plan view of the first and second card carrying-out roller sections L1 and L2 viewed from above a protective film 2a side of the card 1, that is, viewed from the press shaft 107a or 109a side in FIG. 1. A configuration of the second card carrying-out roller section L2 is similar to that of the first card carrying-out roller sections L1, so that description is given to the first card carrying-out roller sections L1 as a representative of the first and second card carrying-out roller sections L1 and L2.

A width W1 of a section of the press shaft 107a having a maximal outer diameter and a width W2 of a section of the card carrying roller 107b having a maximal outer diameter are designated to be approximately equal to or larger than a width Wc of the card 1 respectively.

In this connection, since an end portion E1 of the press shaft 107a and an end portion E2 of the card carrying roller 107b never contact with the card 1, which is carried in an arrow direction in FIG. 6, respectively, a whole surface area of the card 1 that is laminated with a protective film 2a is pressed evenly by the press shaft 107a and the card carrying roller 107b, and resulting in eliminating deviation of internal stress remaining in the card 1. In other words, the card 1 is uniformized in lower stress after the laminating process.

Consequently, the surface of the laminated card 1, that is, a surface of the protective film 2a, which is laminated on the surface 1a of the card 1 by the laminating roller section LR, is hardly scratched by the first and second card carrying-out roller sections L1 and L2, and further the protective film 2a is prevented from wrinkling although the protective film 2a is still in higher temperature and soft.

Furthermore, evenly pressing the protective film 2a eliminates unevenness of bonding the protective film 2a to the card 1, and the protective film 2a results in hardly peeling off by itself with time.

Referring back to FIG. 1, the laminate film feeding section is described in detail next. The laminate film feeding section is composed of the laminate film 2, a supply reel 110, an end mark sensor 111 for detecting a mark (to be detailed later) on the laminate film 2, a film mark sensor 112, a first guide shaft 113, a second guide shaft 114, a take-up roller 115, a heat cam 116, a heat cam pressure position sensor 117, a heat cam stand-by position sensor 118, and a lever 121. The heat cam 116 is provided with a cam section 1116a in prescribed shape. Hereupon, the heat cam 116, the heat cam pressure position sensor 117 and the heat cam stand-by position sensor 118 will be detailed later.

The laminate film 2 to be supplied for laminating is extended from the supply reel 110 to the take-up reel 115 through the laminating roller section LR between the heat roller 106a and the heat press shaft 106b.

Further, as shown in FIG. 1, the end mark sensor 111, the film mark sensor 112, and the first and second guide shafts 113 and 114 are allocated on an extending route of the laminate film 2 respectively.

With referring to FIGS. 1 and 5(a), the laminating process is briefly described next.

FIG. 5(a) is a plan view showing a frame format of the laminating roller section LR and its neighboring area for exhibiting the laminating process conducted by the laminating roller section LR. In FIG. 5(a), the laminate film 2 is extended along the first and second guide shafts 113 and 114 through the laminating roller section LR between the heat roller 106a and the heat press shaft 106b while the laminate film 2 is carried in an arrow “B” direction. The card 1 that is carried in from the card intake slot 101 at a card carrying speed V1 is cooled down by the cooling fan 120 at the upstream side of the laminating roller section LR. The cooled down card 1 is carried in the laminating roller section LR, wherein a protective film 2a provided on a substrate 2b of the laminate film 2 is thermally compression bonded on the surface 1a of the card 1 by the heat roller 106a that presses the card 1 and the laminate film 2 against the heat press shaft 106b while the card 1 is carried at a card feeding speed (hereinafter referred to as laminating speed) V2.

Accordingly, the protective film 2a is laminated on the surface 1a of the card 1.

With referring to FIGS. 1 and 2, a driving system of the laminating apparatus 100 is described in detail next.

Allocation of each component shown in FIG. 2 corresponds to that shown in FIG. 1. In FIG. 2, the components such as the card carrying rollers 103b, 105b, 107b and 109b and the heat cam 116 and the take-up reel 115 are common to those shown in FIG. 1.

The laminating apparatus 100 is provided with a card carrying motor 201, a heat cam motor 206 and a film take-up motor 209 as a driving source.

Motive power of the card carrying motor 201 is transmitted through first to third power transmission routes.

More specifically, with respect to a first power transmission route, the motive power of the card carrying motor 201 is transmitted to an idle gear 203 by way of a motor pulley 201a and a first belt 202, and further transmitted to the card carrying roller 105b of the second card carrying-in roller section R2, which engages with the idle gear 203.

With respect to a second power transmission route, the motive power is also transmitted to the card carrying roller 103b of the first card carrying-in roller section R1 by way of a second belt 204, which is wound around the card carrying roller 105b.

With respect to a third power transmission route, the motive power is transmitted to the card carrying roller 107b of the first card carrying-out roller section L1, which engages with the idle gear 203, and further transmitted to the card carrying roller 109b of the second card carrying-out roller section L2 by way of a third belt 205.

On the other hand, motive power of the heat cam motor 206 is transmitted to the heat cam 116 by way of a worm wheel 207 and an idle gear 208, which engages with the worm wheel 207.

As shown in FIGS. 1 and 2, the heat cam 116 is provided with the cam section 116a in prescribed shape.

The lever 121 shown in FIG. 1 contacts with the cam section 116a while the lever 121 pushes the cam section 116a upward, and reciprocally moves in the vertical direction with sliding along the outer circumferential surface of the cam section 116a when the heat cam 116 rotates. The lever 121 is linked to the heat roller 106a, so that the heat roller 106a moves vertically in accordance with rotation of the heat cam 116 as a result.

Further, a rotational position of the heat cam 116 is detected by the heat cam pressure position sensor 117 and the heat cam stand-by position sensor 118.

More specifically, the heat cam 116 rotates clockwise in FIG. 1 and moves the heat roller 106a downward toward the heat press shaft 106b, and then the heat cam pressure position sensor 117 detects a moment when the heat roller 106a begins to be pressed against the heat press shaft 106b.

On the contrary, the heat cam stand-by position sensor 118 detects a moment when the heat roller 106a begins to be apart from the heat press shaft 106b.

On the other hand, motive power of the film take-up motor 209 is transmitted to the take-up reel 115 by way of a worm wheel 210 and an idle gear 211, which engages with the worm wheel 210.

With referring to FIG. 3, an electrical configuration of the laminating apparatus 100 is described next. The laminating apparatus 100 is provided with the CPU 304 as a controlling device. As shown in FIG. 3, sensor output information from the card detecting sensor 102, the laminating position sensor 104, the card carrying-out sensor 108, the end mark sensor 111, the film mark sensor 112, the heat cam pressure position sensor 117 and the heat cam stand-by position sensor 118 are inputted into the CPU 304.

Further, the CPU 304 is connected to servo circuits 301, 302 and 303, which are hooked up to the card carrying motor 201, the heat cam motor 206 and the film take-up motor 209 respectively.

Furthermore, the CPU 304 is connected to a drive amplifier 305, which is hooked up to the cooling fan 120.

By this electrical configuration, the CPU 304 enables to control the cooling fan 120 through the drive amplifier 305 as well as controlling each of the motors 201, 205 and 209 through each of the servo circuits 301, 302 and 303 respectively in response to each sensor output information to be inputted into the CPU 304.

With referring to FIGS. 1 to 5(b), the laminating operation in the laminating apparatus 100 according to the first embodiment of the present invention is described in detail next.

In FIG. 4, three digit numbers exhibited at the far left of the chart such as 201, 120, 209, 206, 102, 104, 108, 112, 111, 117 and 118 denote the card carrying motor 201, the cooling fan 120, the film take-up motor 209, the heat cam motor 206, the card detecting sensor 102, the laminate position sensor 104, the card carrying-out sensor 108, the film mark sensor 112, the end mark sensor 111, the heat cam pressure position sensor 117 and the heat cam stand-by position sensor 118 respectively.

Further, in FIG. 4, terms “Fwd” and “Lo” denote “forward” and “low” respectively. In case of the card carrying motor 201, for example, the motor 201 rotates in a “Fwd” direction during a first period. In case of the card detecting sensor 102, the sensor 102 transmits a “Lo” level signal to the CPU 304 in the first period. In other words, a level of a signal transmitted from the sensor 102 changes from “High” to “Lo” at a moment when the first period begins.

In the laminating apparatus 100, when laminating a protective film 2a on a card 1, the CPU 304 controls the laminating speed V2 shown in FIG. 5(a) with respect to the card 1 and the laminate film 2 in multiple stage of speed so as to optimize lamination quality in accordance with variations of the card 1 or the laminate film 2 in material and thickness.

More specifically, in the laminating apparatus 100, the laminating speed V2 enables to be adjusted within a range from 4.0 mm/s to 9.0 mm/s by an interval of 0.5 mm/s.

In following descriptions of the laminating operation, it is defined that the laminating speed V2 is constantly 4.0 mm/s.

Hereupon, the laminate film 2 is described briefly. There are two types of films. The one is a so-called “patch film” that is constituted by a piece of laminate film or protective film 2a having a size almost equivalent to that of the card 1, which is successively bonded on a base film or substrate 2b as shown in FIG. 5(b). The other is a so-called an “overlay film” that is constituted by a thermo adhesive resin, which enables to be thermally bonded on a surface of the card 1 and is coated on a base tape or substrate in ribbon shape.

In the following descriptions of the laminating operation, it is described by using a patch film type laminate film.

Further, the laminating operation is sequentially divided into six periods from first to sixth periods in time series for easier understanding.

1. First Period: Card Carrying-In Operation

When a card 1 is inserted into the laminating apparatus 100 through the card intake slot 101 by means of manpower or a not shown carrying-in device, the card detecting sensor 102 detects that the card 1 is inserted. As shown in FIG. 4, the card detecting sensor 102 transmits a detection signal “Lo” to the CPU 304 when the card detecting sensor 102 detects the card 1. The CPU 304 directs the servo circuit 301 in accordance with the detection signal “Lo” to rotate the card carrying motor 201 in a “Fwd” direction so as for the card 1 to be carried toward the card carrying-out slot 119. Hereinafter such a direction toward the card carrying-out slot 119 is referred to as a forward direction.

Accordingly, the card 1 is carried inside the laminating apparatus 100 such that the card 1 is caught between the press shaft 103a and the card carrying roller 103b of the first card carrying-in roller section R1, and succeedingly between the press shaft 105a and the card carrying roller 105b of the second card carrying-in roller section R2.

At the same time, the CPU 304 activates the cooling fan 120 to be turned “ON” through the drive amplifier 305. By wind generated by the cooling fan 120, the card 1 is cooled down as low as the normal temperature or ambient temperature of the laminating apparatus 100 even when the card 1 is in high temperature due to a preceding process such as a printing process.

When the card 1 passes through the card detecting sensor 102 completely, the card detecting sensor 102 stops outputting the detection signal “Lo”. In other words, the detection signal “Lo” returns to a “High” level as shown in FIG. 4. When the detection signal “Lo” is interrupted, the CPU 304 conducts the card carrying motor 201 to stop its rotation through the servo circuit 301 after the card 1 is carried as far as a prescribed distance. In this connection, the direction to stop the card carrying motor 201 rotating is a final moment of a second period (to be detailed later) in FIG. 4.

Further, it is also acceptable for the direction to stop the card carrying motor 201 rotating that the direction is transmitted in response to an output signal from the laminating position sensor 104.

The card carrying speed V1 until the final moment of the second period does not directly affect the laminating process, so that the card carrying speed V1 enables to be designated at a highest speed as long as carrying and cooling operations are not obstructed.

The CPU 304 appropriately controls the cooling fan 120 to be turned off so as for temperature of the heat roller 106a not to be lowered more than necessary. In other words, the cooling fan 120 is allocated such that air blasting from the cooling fan 120 reaches only to the card 1, and further the cooling fan 120 is controlled in its moment of air blasting by the CPU 304. As shown in FIG. 4, the cooling fan 120 is turned off at the end of the first period.

A number of revolutions and operating time of the cooling fan 120 enable to be set by an operator through a not shown input section for operation.

Further, by providing an infrared thermo-sensor for measuring surface temperature of the card 1 or a temperature sensor for measuring neighborhood temperature of the card 1 so as to be alternate temperature of the card 1, it is also acceptable for the CPU 304 to control the cooling fan 120 in response to an output signal from such an infrared thermo-sensor or a temperature sensor.

Furthermore, in case that the card 1 is stopped at a position where the card 1 confronts with the cooling fan 120 in response to a signal from the card detecting sensor 102 or the laminating position sensor 104, and that the cooling fan 120 is turned on only while the card 1 keeps stopping, the heat roller 106a enables to be prevented from lowering its temperature as well as improving cooling efficiency of the card 1.

2. Second Period: Setting Operation of Laminating Position

During a second period, the card carrying motor 201 is continuously driven in succession to the first period. Consequently, the card 1 is carried in the card carrying-out direction or the forward direction.

3. Third Period: Contacting Operation of Heat Roller

The card detection signal “Lo” is interrupted at a moment when the card 1 passes through the laminating position sensor 104. In this connection, the CPU 304 stops the card carrying motor 201 rotating when a card detection signal “High” outputted from the laminating position sensor 104 is transmitted to the CPU 304. Hereupon, it is also acceptable for the card carrying motor 201 to be turned off after the card 1 is moved by a distance equivalent to a prescribed amount of offset distance.

The CPU 304 directs the servo circuit 302 to drive the heat cam motor 206 so as to rotate the heat cam 116 in response to the card detection signal “High” transmitted from the laminating position sensor 104. Rotating the heat cam 116 results in pressing the heat roller 106a down the heat press shaft 106b.

Then, the CPU 304 stops the heat cam motor 206 rotating in response to an output signal from the heat cam pressure position sensor 117 when it is confirmed that the heat roller 106a reaches to a position at where the heat roller 106a presses against the heat press shaft 106b.

4. Fourth Period: Laminating Operation

The CPU 304 activates the card carrying motor 201 through the servo circuit 301 so as to carry the card 1 in the forward direction at the laminating speed V2. A distance of the card 1 to be carried in the forward direction at the laminating speed V2 is at least a maximum length along the card 1 in the carrying direction of the card 1 within an area for laminating the protective film 2a on the surface 1a of the card 1.

Further, at the same time, the CPU 304 directs the servo circuit 309 to rotate the film take-up motor 209 in a take-up direction of the laminate film 2 shown by the arrow “B” in FIGS. 1 and 5(a) in synchronism with the laminating speed V2.

5. Fifth Period: Operations of Separating Heat Roller and Peeling Off Film

The CPU 304 activates the heat cam motor 206 to rotate through the servo circuit 302 so as to move the heat roller 106a upward when the heat cam pressure position sensor 117 transmits a “Lo” level signal to the CPU 304, and then the CPU 304 stops the heat cam motor 206 rotating when a detection signal “High” of the cam section 116a outputted from the heat cam stand-by position sensor 118 is inputted into the CPU 304.

On the other hand, the CPU 304 activates the card carrying motor 201 to carry the card 1 in the forward direction by a prescribed distance, and then the CPU 304 activates the card carrying motor 201 to stop the card 1 being carried.

When the card 1 and the laminate film 2 are integrally carried in the forward direction and a front end tip of the card 1 reaches to the second guide shaft 114, the substrate 2b of the laminate film 2 is pulled obliquely upward in the arrow “B” direction in FIGS. 1 and 5(a) in the downstream side of the guide roller 114, wherein the front end tip is one tip of the card 1 toward the card carrying-out slot 119 along the forward direction and the other tip toward the card intake slot 101 is referred to as a back end tip. Consequently, the protective film 2a is separated from the substrate 2b of the laminate film 2, and the substrate 2b is taken up by the take-up reel 115 while the protective film 2a is bonded on the surface 1a of the card 1.

As shown in FIG. 5(b), a film mark 2c is marked on the substrate 2b of the laminate film 2 in response to a prescribed bonding pitch of the protective film 2a, which is affixed on the substrate 2b. When the end mark sensor 111 detects the film mark 2c, as shown in FIG. 4, the end mark sensor 111 transmits a “Lo” level signal to the CPU 304, and then the CPU 304 stops the film take-up motor 209 rotating.

On the other hand, in case the laminate film 2 is an overlay type film, rotation of the film take-up motor 209 is interrupted in accordance with stopping the card carrying motor 201 rotating.

6. Sixth Period: Card Carrying-Out Operation

The CPU 304 directs the servo circuit 301 to drive the card carrying motor 201, and activates the card carrying rollers 107b and 109b so as to carry the card 1 in the forward direction toward the card carrying-out slot 119. Then the CPU 304 directs the servo circuit 301 to stop the card carrying motor 201 rotating in succession to a moment when the card carrying-out sensor 108 disables to detect the card 1 any more. Consequently, the card 1 laminated with the protective film 2a, that is, the laminated card 1 is carried out externally from the card carrying-out slot 119 of the laminating apparatus 100.

Accordingly, the card 1 is laminated with the protective film 2a by being conducted through the operations detailed in the first to sixth periods mentioned above.

### Second Embodiment

FIG. 7 is a plan view showing a frame format of a card printing apparatus according to a second embodiment of the present invention.

With referring to FIG. 7, a card printing apparatus, which is equipped with both a printing function for printing information on a card and a laminating function for conducting a laminating process on a surface of a card that is printed by means of the printing function, is described in detail next.

As shown in FIG. 7, a card printing apparatus 200 is composed of a printing section 50P and a laminating section 50L. A fundamental configuration of the laminating section 50L is similar to that of the laminating apparatus 100 according to the first embodiment of the present invention shown in FIG. 1.

A printing method of the card printing apparatus 200 is not limited to a particular one. However, it shall be understood that the card printing apparatus 200 enables to ensure a laminated card more excellent in quality with effectively preventing the card from warping even by the thermal transfer printing method, in particular, which requires heating to be applied to the card.

In FIG. 7, a card 1, which is inserted into the card printing apparatus 200 through a card intake slot 51 by means of manpower or a not shown inserting device, is carried to an internal printing head section “H” by means of a first card carrying-in roller section T1 that is constituted by a pair of rollers 52a and 52b.

The printing head section “H” is composed of a thermal head 57, which is mounted with printing ink, and a platen roller 55, which pushes a surface 1a for printing of the card 1 upward against the thermal head 57.

The thermal head 57 prints a prescribed letter or image on the surface 1a of the card 1 by heating the mounted printing ink in response to instructions from a not shown printing control section.

After the card 1 is printed, the printed card 1 is carried into the laminating section 50L, which is allocated adjacent to the printing section 50P, by means of a second card carrying-in roller section T2 that is constituted by a pair of rollers 53a and 53b.

In the laminating section 50L, the printed card 1, which is carried therein from the printing section 50P, is carried to a laminating roller section LR for thermo compression bonding by means of a third card carrying-in roller section T3 that is constituted by a pair of rollers 54a and 54b.

Configurations and operations of the laminating roller section LR and sections and components, which are allocated in a downstream side of the laminating roller section LR, are similar to those of the laminating apparatus 100 according to the first embodiment of the present invention.

The card 1 of which surface 1a is conducted through the laminating process, is finally carried out from the card printing apparatus 200 through a card carrying-out slot 56.

In the card printing apparatus 200, which is constituted as mentioned above, a cooling fan 120 is allocated between the printing head section “H” of the printing section 50P and the laminating roller section LR, and cools down the printed card 1 at a prescribed moment immediately before the printed card 1 is carried in the laminating roller section LR.

Accordingly, the card 1 is cooled down as low as the normal temperature at the moment when the card 1 is carried in the laminating roller section LR although the card 1 is carried out from the printing section 50P with keeping in high temperature.

### Third Embodiment

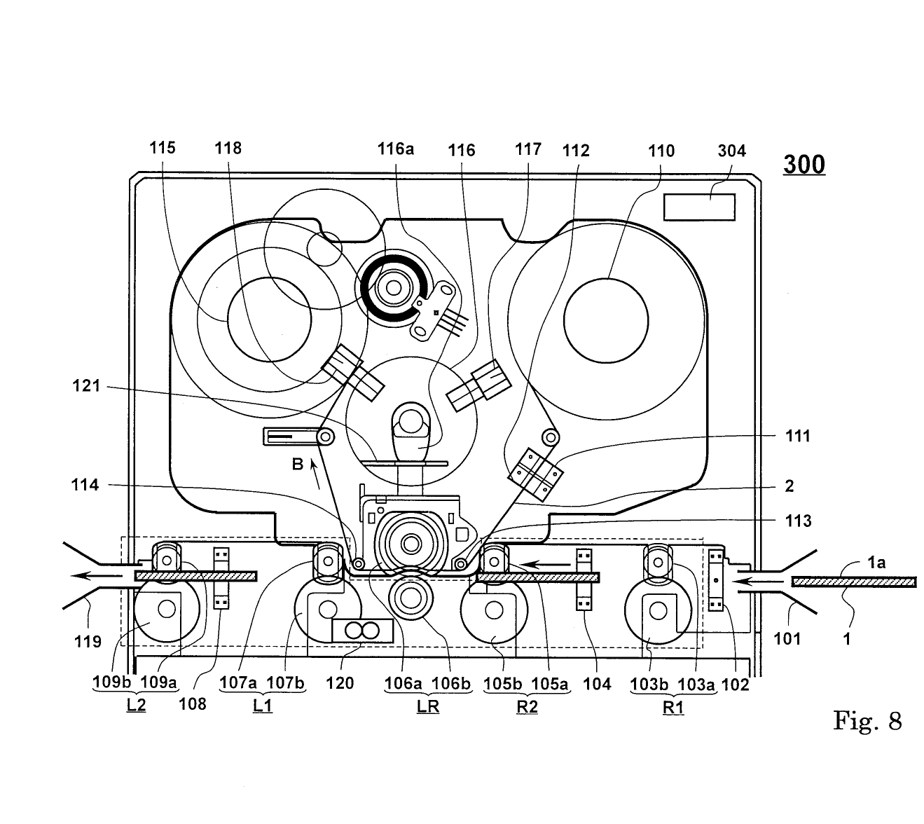

FIG. 8 is a plan view of a laminating apparatus according to a third embodiment of the present invention showing an internal constitution.

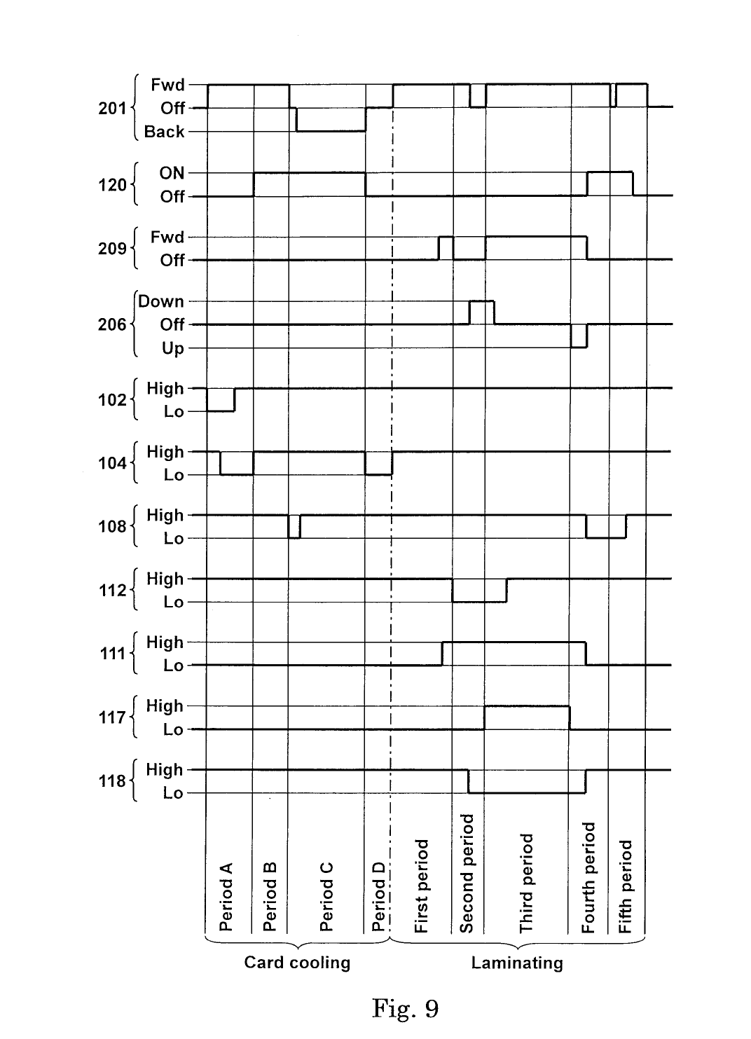

FIG. 9 is a timing chart of the laminating apparatus shown in FIG. 8 according to the third embodiment of the present invention.

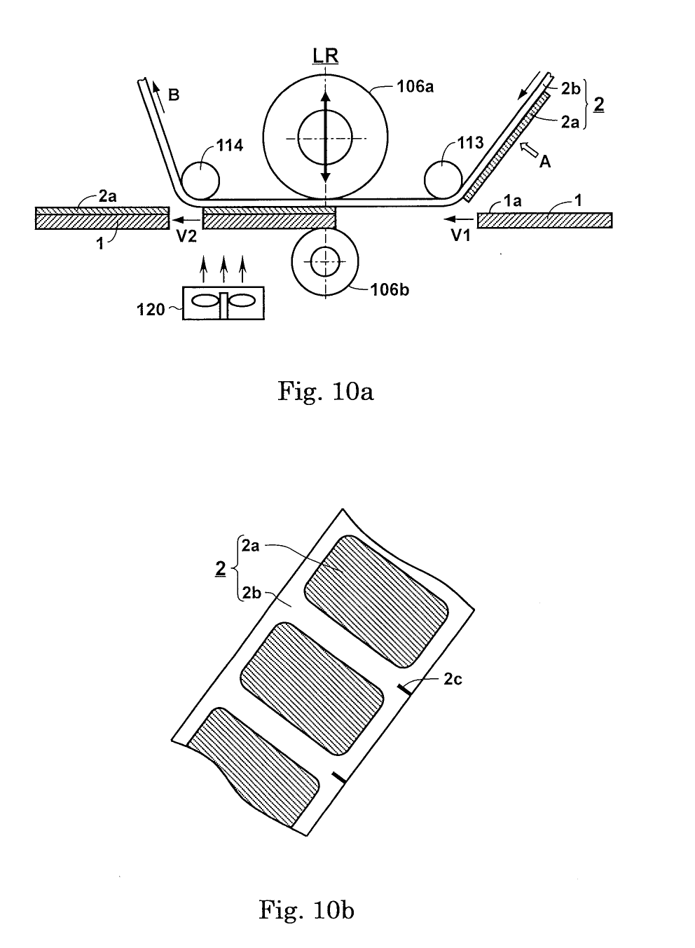

FIG. 10(a) is a plan view showing a frame format of a major part of the laminating apparatus shown in FIG. 8.

FIG. 10(b) is a plan view of a laminate film viewed from an arrow “A” direction in FIG. 10(a).

A laminating apparatus 300 according to a third embodiment of the present invention shown in FIG. 8 is identical to the laminating apparatus 100 according to the first embodiment of the present invention shown in FIG. 1 except for a location of the cooling fan 120. Therefore, in FIG. 8, the same components and sections as those of the laminating apparatus 100 are denoted by the same reference signs, and their details are omitted. The descriptions corresponding to FIGS. 2, 3 and 6 are also applied to the laminating apparatus 300 according to the third embodiment of the present invention.

As shown in FIGS. 8 and 10(a), in the laminating apparatus 300 according to the third embodiment of the present invention, a cooling fan 120 is allocated between the laminating roller section LR and the second guide shaft 114 in the downstream side of the laminating roller section LR nearby the carrying route of the card 1 so as to confront with the card 1.

With referring to FIGS. 2, 3 and 8-10(b), a laminating operation of the laminating apparatus 300 is described in detail next.

The laminating operation of the laminating apparatus 300 is divided broadly into two phases. The one is a laminating operation phase for conducting a laminating process to a card 1, and the other is a card cooling operation phase that is a preceding phase prior to the laminating operation phase.

The laminating operation phase is further divided into five periods from a first period to a fifth period, and the card cooling operation phase is further divided into four periods from a period “A” to a period “D”.

Further, in the laminating apparatus 300, when laminating a protective film 2a on a card 1, the CPU 304 controls a feeding speed or laminating speed V2 of the card 1 and the laminate film 2 in multiple stage of speed so as to optimize lamination quality in accordance with variations of the card 1 or the laminate film 2 in material and thickness.

More specifically, in the laminating apparatus 100, the laminating speed V2 enables to be adjusted within a range from 4.0 mm/s to 9.0 mm/s by an interval of 0.5 mm/s.

In following descriptions of the laminating operation, it is defined that the laminating speed V2 is constantly 4.0 mm/s.

In addition thereto, in the following descriptions of the laminating operation, it is described by using a patch film type laminate film.

A description is given to the card cooling operation phase first.

In FIG. 9, terms “Fwd”, “Back” and “Lo” denote “forward”, “backward” and “low” respectively. In case of the card carrying motor 201, for example, the motor 201 rotates in a “Fwd” direction during periods “A” and “B” so as to carry a card 1 in the forward direction toward the card carrying-out slot 119, and then the motor 201 rotates in a “Back” direction during a period “C” so as to carry the card 1 in the backward direction toward the card intake slot 101.

Further, in case of the card detecting sensor 102, the card detecting sensor 102 transmits a “Lo” level signal to the CPU 304 in the period “A”. In other words, a level of a signal transmitted from the sensor 102 changes from “High” to “Lo” when the period “A” begins.

Furthermore, in FIG. 9, three digit numbers exhibited at the far left of the chart such as 201, 120, 209, 206, 102, 104, 108, 112, 111, 117 and 118 are identical to those shown in FIG. 4, so that their details are omitted.

1. Period “A”: Card Carrying-In Operation

When a card 1 is inserted into the laminating apparatus 300 through the card intake slot 101 by means of manpower or a not shown carrying-in device, the card detecting sensor 102 detects that the card 1 is inserted. As shown in FIG. 9, the card detecting sensor 102 outputs a detection signal “Lo” to the CPU 304. The CPU 304 directs the servo circuit 301 in response to the detection signal “Lo” to rotate the card carrying motor 201 in a “Fwd” direction so as for the card 1 to be carried in the forward direction toward the card carrying-out slot 119.

Consequently, the card 1 is carried inside the laminating apparatus 300 while the card 1 is caught between the press shaft 103a and the card carrying roller 103b of the first card carrying-in roller section R1, and succeedingly between the press shaft 105a and the card carrying roller 105b of the second card carrying-in roller section R2.

When the laminating position sensor 104 detects the card 1 in succession to the card detecting sensor 102, the laminate position sensor 104 transmits a card detection signal “Lo” to the CPU 304.

2. Period “B”: Card Cooling Operation

When the card 1 is carried inside the laminating apparatus 300 while the card 1 passes through the card detecting sensor 102 and the laminating position sensor 104 in the forward direction respectively, the detection signals of the card detecting sensor 102 and the laminating position sensor 104 sequentially become a “High” level. More specifically, when the laminating position sensor 104 disables to detect the card 1 any more, the laminating position sensor 104 transmits the card detection signal in “High” level to the CPU 304. The CPU 304 activates the cooling fan 120 to turn “ON” through the drive amplifier 305 at the moment when the laminating position sensor 104 disables to detect the card 1.

When the laminating position sensor 104 disables to detect the card 1 while the card 1 is carried in the forward direction, the card 1 is located at a position, which is short of the laminating roller section LR, at where the front end tip of the card 1 begins to be caught in the laminating roller section LR.

Further, at the time when the card 1 is located at the above-mentioned position, the heat roller 106a is separated from the heat press shaft 106b of the laminating roller section LR. The card 1 is carried through a gap between the heat roller 106a and the heat press shaft 106b in the forward direction toward the card carrying-out slot 119, and then the card 1 is cooled down as low as the normal temperature by the cooling fan 120.

3. Period “C”: Card Inversely Carrying Operation

When the front end tip of the card 1 reaches to a position at where the card carrying-out sensor 108 is allocated, as shown in FIG. 9, the card carrying-out sensor 108 transmits a card detection signal “Lo” to the CPU 304.

In response to the card detection signal “Lo” transmitted from the card carrying-out sensor 108, the CPU 304 directs the servo circuit 301 to rotate the card carrying motor 201 in a “Back” direction so as to carry the card 1 in the backward direction toward the card intake slot 101.

Accordingly, the card 1 is carried in the backward direction toward the card intake slot 101 through the laminating roller section LR by way of the second card carrying-in roller section R2. During the inversely carrying operation of the card 1, the card 1 is also cooled down by the cooling fan 120 when the card 1 is carried across a front of the cooling fan 120 in the backward direction.

4. Period “D”: End of Cooling Operation and Setting Operation of Laminating Position

When the laminating position sensor 104 detects the back end tip of the card 1 toward the card intake slot 101 and transmits a card detection signal “Lo” to the CPU 304, the CPU 304 stops the cooling fan 120 blowing and the card carrying motor 201 rotating. Consequently, the card cooling operation phase ends hereupon.

In case the cooling operation with respect to the card 1 is conducted such that the cooling fan 120 is activated only while the card 1 is kept stopping at a position, which confronts with the cooling fan 120, in accordance with a signal transmitted from the laminating position sensor 104, temperature of the heat roller 106a enables to be prevented from being excessively lowered as well as improving cooling efficiency of the cooling fan 120.

Continuously, the laminating operation phase begins in succession to the card cooling operation phase. The laminating operation phase is described in detail next.

5. First Period: Laminating Position Setting Operation

When a prescribed period of time has elapsed after the period “D” ended, the CPU 304 activates the card carrying motor 201 to rotate in the “Fwd” direction, that is, to carry the card 1 in the forward direction toward the laminating roller section LR or the card carrying-out slot 119.

Further, the CPU 304 activates the film take-up motor 209 to rotate in the “Fwd” direction so as to carry the laminate film 2 in the arrow “B” direction, and then directs the film take-up motor 209 to stop at a moment when the film mark sensor 112 detects a film mark 2c on the substrate 2b of the laminate film 2 and transmits a detection signal “Lo” to the CPU 304.

Accordingly, the laminate film 2 is positioned.

6. Second Period: Heat Roller Pressing Operation

Successively, the CPU 304 directs the servo circuit 302 to drive the heat cam motor 206 to rotate in a “Down” direction so as to rotate the heat cam 116. The heat cam 116 moves the heat roller 106a downward toward the heat press shaft 106b.

7. Third Period: Laminating Operation

When an output signal “High” outputted from the heat cam pressure position sensor 117 is transmitted to the CPU 304, the CPU 304 directs the servo circuit 302 to stop the heat cam motor 206 rotating in response to the output signal “High”. The heat cam motor 206 is stopped rotating when it is confirmed that the heat roller 106a reaches to a position at where the heat roller 106a is pressed against the heat press shaft 106b.

Then, the CPU 304 activates the card carrying motor 201 through the servo circuit 301 so as to carry the card 1 in the forward direction or the card carrying-out direction at the laminating speed V2. A distance of the card 1 to be carried in the forward direction at the laminating speed V2 is at least a maximum length along the card 1 in the carrying direction of the card 1 within an area for laminating the protective film 2a on the surface 1a of the card 1.

Further, at the same time, the CPU 304 directs the servo circuit 303 to rotate the film take-up motor 209 so as to take up the laminate film 2 in a take-up direction or in the arrow “B” direction shown in FIGS. 8 and 10(a) in synchronism with the laminating speed V2.

8. Fourth Period: Operations of Separating Heat Roller and Peeling Off Film

The CPU 304 through the servo circuit 302 activates the heat cam motor 206 to rotate so as to move the heat roller 106a upward, and then stops the heat cam motor 206 rotating when a detection signal “High” of the cam section 116a outputted from the heat cam stand-by position sensor 118 is inputted into the CPU 304.

On the other hand, the CPU 304 activates the card carrying motor 201 to carry the card 1 in the forward direction as far as a prescribed distance, and then stops the card 1 moving.

Further, the CPU 304 activates the cooling fan 120 to turn “ON”, and the laminated card 1 is cooled down. With respect to activating the cooling fan 120, it is also acceptable that the cooling fan 120 is activated during the third period so as to cool down the card 1 immediately after the card 1 is conducted through the laminating process.

When the card 1 and the laminate film 2 are integrally carried in the forward direction toward the card carrying-out slot 119 and the front end tip of the card 1 reaches to the guide shaft 114, the substrate 2b of the laminate film 2 is pulled obliquely upward in the arrow “B” direction in FIGS. 8 and 10(a) in the downstream side of the second guide roller 1114. Consequently, the substrate 2b is separated from the laminate film 2 and taken up by the take-up reel 115 while the protective film 2a is bonded on the surface 1a of the card 1.

As shown in FIG. 10(b), a film mark 2c is marked on the substrate 2b of the laminate film 2 in response to a prescribed bonding pitch of the protective film 2a, which is affixed on the substrate 2b. When the end mark sensor 111 detects the film mark 2c, as shown in FIG. 9, the end mark sensor 111 transmits a “Lo” level signal to the CPU 304, and then the CPU 304 stops the film take-up motor 209 rotating.

On the other hand, in case the laminate film 2 is an overlay type film, rotation of the film take-up motor 209 is interrupted in synchronism with stopping the card carrying motor 201 rotating.

9. Fifth Period: Card Carrying-Out Operation

The CPU 304 directs the servo circuit 301 to drive the card carrying motor 201 to rotate in the “Fwd” direction, and activates the card carrying rollers 107b and 109b so as to carry the card 1 in the forward direction toward the card carrying-out slot 119. Then the CPU 304 directs the servo circuit 301 to stop the card carrying motor 201 rotating subsequently the card carrying-out sensor 108 disables to detect the card 1 any more. Consequently, the card 1 laminated with the protective film 2a, that is, the laminated card 1 is carried out externally from the card carrying-out slot 119 of the laminating apparatus 100.

Accordingly, as detailed above, the card 1 is laminated with the protective film 2a by applying the operations detailed in the first to fifth periods mentioned above.

### Fourth Embodiment

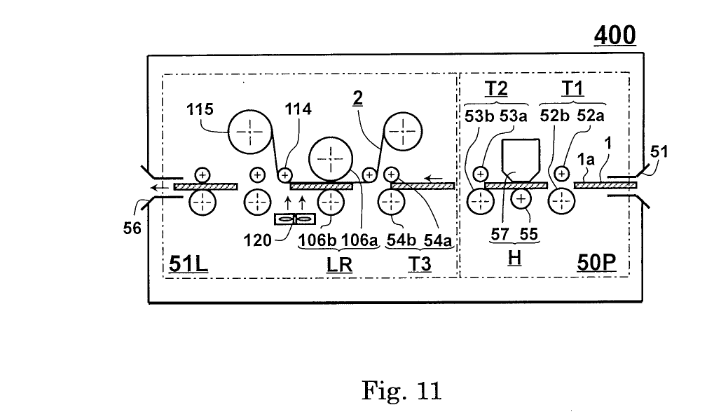

FIG. 11 is a plan view showing a frame format of a card printing apparatus according to a fourth embodiment of the present invention.

With referring to FIG. 11, a card printing apparatus, which is equipped with both a printing function for printing information on a card and a laminating function for conducting a laminating process on a surface of a card that is printed by means of the printing function, is described in detail next.

A card printing apparatus 400 according to a fourth embodiment of the present invention shown in FIG. 11 is identical to the card printing apparatus 200 according to the second embodiment of the present invention shown in FIG. 7 except for a location of the cooling fan 120. Therefore, in FIG. 11, the same components and sections as those of the card printing apparatus 200 are denoted by the same reference signs and their details are omitted.

As shown in FIG. 11, a card printing apparatus 400 is composed of the printing section 50P and a laminating section 51L. A fundamental configuration of the laminating section 51L is similar to that of the laminating apparatus 300 according to the third embodiment of the present invention shown in FIG. 8.

A printing method of the card printing apparatus 400 is not limited to a particular one. However, it shall be understood that the card printing apparatus 400 enables to ensure a laminated card, which is more excellent in quality, with effectively preventing the card from warping even by the thermal transfer printing method, in particular, which requires heating to be applied to the card.

In FIG. 11, a card 1, which is inserted into the card printing apparatus 400 through a card intake slot 51 by means of manpower or a not shown inserting device, is carried in an internal printing head section “H” by means of a first card carrying-in roller section T1 that is constituted by a pair of rollers 52a and 52b.

The printing head section “H” is composed of a thermal head 57, which is mounted with printing ink, and a platen roller 55, which pushes a surface 1a to be printed of a card 1 upward against the thermal head 57.

The thermal head 57 prints a prescribed letter or image on the surface 1a of the card 1 by heating the mounted printing ink according to instructions from a not shown printing control section.

After the card 1 is printed, the printed card 1 is carried into the laminating section 51L, which is allocated adjacent to the printing section 50P, by means of a second card carrying-in roller section T2 that is constituted by a pair of rollers 53a and 53b.

In the laminating section 51L, the printed card 1, which is carried therein from the printing section 50P, is further carried to a laminating roller section LR for thermo compression bonding by means of a third card carrying-in roller section T3 that is constituted by a pair of rollers 54a and 54b.

Configurations and operations of the laminating roller section LR and its downstream side are similar to those of the laminating apparatus 100 or 300 according to the first or third embodiment of the present invention. Therefore further details are omitted.

The card 1, which is conducted through the laminating process on the surface 1a, is finally carried out from the card printing apparatus 200 through a card carrying-out slot 56.

In the above-mentioned configuration of the card printing apparatus 400, a cooling fan 120 is allocated between the laminating roller section LR and a second guide shaft 114, which functions as a separating section for separating the protective film 2a from the substrate 2b of the laminate film 2.

Prior to the laminating process, the card 1 that is printed in the printing section 50P is once passed through the laminating roller section LR without being laminated, and carried as far as a position at where the card 1 confronts with the cooling fan 120, and then the card 1 is cooled down by the cooling fan 120 thereat.

Succeedingly, the cooled-down card 1 is carried back in the backward direction toward the card intake slot 51 as far as an upstream side of the laminating roller section LR. Then, the card 1 is carried once again in the forward direction toward the card carrying-out slot 56, and the card 1 is conducted through the laminating process in the laminating roller section LR.

Accordingly, the card 1 is already cooled down as low as the order of the normal temperature when the card 1 is laminated in the laminating roller section LR although the card 1 is carried out from the printing section 50P as it keeps higher temperature.

As mentioned above, any of the laminating apparatus 100 according to the first embodiment, the card printing apparatus 200 according to the second embodiment, the laminating apparatus 300 according to the third embodiment and the card printing apparatus 400 according to the fourth embodiment is constituted such that a card 1 is cooled down as low as the order of the normal temperature by the cooling fan 120, which is provided in the neighborhood of the card carrying-in route of the laminating apparatus 100 or 300, or in the neighborhood of the card carrying route from the printing section 50P to the laminating section 50L or 51L of the card printing apparatus 200 or 400 prior to thermally compression bonding the laminate film 2 on the card 1, and then the card 1 is conducted through the laminating process.

By this configuration, although the card 1 that is high in temperature is inserted into the laminating apparatus 100 or 300 or carried in the laminating section 50L or 51L of the card printing apparatus 200 or 400, the card 1 is prevented from being excessively heated so high as to be higher temperature more than necessary due to accumulated heating caused by thermo compression bonding.

Accordingly, the card 1 is effectively prevented from being deformed.

Particularly, in case the card 1 is made from a cheaper material having less heat resistance, extremely distinctive effects are exhibited by the above-mentioned configurations.

Further, in the laminating apparatus 300 according to the third embodiment and the card printing apparatus 400 according to the fourth embodiment, the card 1 is cooled down to the order of the normal temperature prior to the laminating process, and then the card 1 is cooled down once again to the order of the normal temperature by the cooling fan 120 prior to separating the substrate 2b from the laminate film 2 or peeling off the protective film 2a from the substrate 2b even after the card 1 is heated through the laminating process.

Accordingly, the laminated card 1 is prevented from being deformed by a force applied to the card 1 when separating the substrate 2b from the laminate film 2.

Furthermore, as mentioned above, in the first to fourth embodiment, the cooling fan 120 is controlled so as to send air only when the card 1 is positioned at a location where the card 1 confronts with the cooling fan 120. Consequently, there is no possibility of cooling down the heat roller 106a so excessively as to affect the heat roller 106a to function.

In the laminating apparatus 100 according to the first embodiment of the present invention, the cooling fan 120 enables to be allocated at any position on the card carrying-in route in the upstream side of the laminating roller section LR.

Further, in the card printing apparatus 200 according to the second embodiment, the cooling fan 120 enables to be allocated at any position on the card carrying route from the printing section 50P to the laminating section 50L.

Furthermore, in the laminating apparatus 300 according t the third embodiment and the card printing apparatus 400 according to the fourth embodiment, the cooling fan 120 enables to be allocated at any position between the laminating roller section LR and the separating section of the laminate film 2 in the downstream side of the laminating roller section LR.

According to an aspect of the present invention, occurrence of defects enables to be reduced during a separating process of a laminate film.

Further, after a card has been laminated, warpage of the card or changing in characteristics of the card with time enables to be improved.

Accordingly, a laminated card, which is low in price and excellent in quality, enables to be manufactured.

While the invention has been described above with reference to specific embodiments thereof, it is apparent that many changes, modifications and variations in the arrangement of equipment and devices can be made without departing from the invention concept disclosed herein.

For example, in the third and fourth embodiments, it is described such that the card 1 before laminating is cooled down by the cooling fan 120 while the card 1 is passed through the laminating roller section LR in the forward direction without conducting the thermo compression bonding process or the laminating process, and passed once again through the laminating roller section LR without conducting the laminating process while carrying the card 1 in the upstream direction of the laminating roller section LR or in the backward direction, and then the card 1 is laminated with the protective film 2a on the surface 1a of the card 1 through the laminating process while the card 1 is carried in the downstream direction or in the forward direction, and finally the laminated card 1 is carried out through the card carrying-out slot 119 or 56. However, the configuration is not limited to the one specifically described above.

It is also acceptable for the configuration of the laminating apparatus or the laminating section to be arranged such that the laminating process is conducted by the laminating roller section LR at a time when the card 1 is carried in the backward direction after the card 1 is cooled down, and then the laminated card 1 is carried in the forward direction through the laminating roller section LR without conducting the thermo compression bonding process, and finally the card 1 is carried out through the card carrying-out slot 119 or 56.

Further, in the first to fourth embodiment, the cooling fan 120 is exemplified as a cooling device. However, such a cooling device is not limited to a fan. By allocating a cooling body that is cooled by using Peltier elements, for example, on the card carrying route, it is acceptable for cooling the card 1 that the card 1 is contacted with or approached to the cooling body so as to cool down the card 1. With respect to a cooling device, commonly known devices enable to be used for such a cooling device.

Furthermore, in the first to fourth embodiment, it is exemplified that the motors 201, 206 and 209 are controlled by means of the servo circuits 301 to 303 respectively. However, by using stepping motors for the motors 201, 206 and 209, the controlling system enables to be constituted such that the CPU 304 controls directly the motors 201, 206 and 209 without using the servo circuits 301 to 303.

With respect to information to be recorded or printed on a surface of a card, such information are letters including numbers and signs and images including hologram.

Further, with respect to a recording method, printing is a typical example. However, it shall be understood that there exist various kinds of recording method.

Furthermore, in the first to fourth embodiment, it is described that the card 1 is inserted into the apparatus through the card intake slot 101 or 51. However, the configuration of inserting the card 1 is not limited to the specific description in the embodiments. It is acceptable for the card inserting configuration that a holder containing a plurality of cards 1 is loaded into the apparatus as a card supplying device. The laminating apparatus or the card printing apparatus according to the present invention is just required for being installed with such a supplying device having a function of supplying the card 1 to the apparatus such as an inserting slot and a holder.

It will be apparent to those skilled in the art that various modification and variations could be made in the present invention without departing from the scope or spirit of the invention.

What is claimed as new and desired to be protected by Letters Patent of the United States is:

1. A manufacturing method of a laminated card comprising the steps of:
cooling for cooling a card; and
thermo compression bonding for thermally compression bonding the card cooled through the step of cooling and a laminate film having a material for forming a protective film so as to produce a laminated card by bonding the material for forming a protective film on at least one surface of the card.

2. The manufacturing method of a laminated card in accordance with claim 1, further comprising the step of:
printing for printing information on the one surface of the card prior to the step of cooling.

3. The manufacturing method of a laminated card in accordance with claim 1, wherein the step of cooling is conducted at an upstream side with respect to a thermo compression bonding section for conducting the step of thermo compression bonding in a carrying direction of the card.

4. The manufacturing method of a laminated card in accordance with claim 1, wherein the step of cooling is conducted at a downstream side with respect to a thermo compression bonding section for conducting the step of thermo compression bonding in a carrying direction of the card.

5. The manufacturing method of a laminated card in accordance with claim 4, further comprising the steps of:
first carrying for carrying the card in the carrying direction from the upstream side to the downstream side with respect to the thermo compression bonding section without thermally compression bonding the laminate film on the card by the thermo compression bonding section prior to the step of cooling; and
second carrying for carrying the card in an opposite direction from the downstream side to the upstream side reversed in the carrying direction of the card after the step of cooling.

6. The manufacturing method of a laminated card in accordance with claim 5, further comprising the step of:
third carrying for carrying the card in the carrying direction from the upstream side to the downstream side while thermally compression bonding the laminate film on the card by the thermo compression bonding section after the step of second carrying.

7. A laminating apparatus for manufacturing a laminated card comprising:
a cooling section for cooling a card; and
a thermo compression bonding section for thermally compression bonding the card cooled in the cooling section and a laminate film having a material for forming a protective film so as to produce a laminated card by bonding the material for forming a protective film on at least one surface of the card.

8. The laminating apparatus in accordance with claim 7, further comprising:
a printing section for printing information on the one surface of the card prior to cooling the card by the cooling section.

9. The laminating apparatus in accordance with claim 7, wherein the cooling section is provided at an upstream side with respect to the thermo compression bonding section in a carrying direction of the card.

10. The laminating apparatus in accordance with claim 7, wherein the cooling section is provided at a downstream side with respect to the thermo compression bonding section in a carrying direction of the card.

11. The laminating apparatus in accordance with claim 10, further comprising:
first carrying means for carrying the card in the carrying direction from the upstream side to the downstream side with respect to the thermo compression bonding section without thermally compression bonding the laminate film on the card by the thermo compression bonding section prior to cooling the card by the cooling section; and
second carrying means for carrying the card in an opposite direction from the downstream side to the upstream side reversed in the carrying direction of the card after cooling the card by the cooling section.

12. The laminating apparatus in accordance with claim 11, further comprising:
third carrying means for carrying the card in the carrying direction from the upstream side to the downstream side while thermally compression bonding the laminate film on the card in the thermo compression bonding section after the card is carried from the downstream side to the upstream side by the second carrying means.

13. A card printing apparatus comprising:
a printing section for printing information on at least one surface of a card;
a cooling section for cooling the card printed by the printing section; and
a thermo compression bonding section for thermally compression bonding the card cooled by the cooling section and a laminate film having a material for forming a protective film so as to produce a laminated card by bonding the material for forming a protective film on the one surface of the card.

14. The card printing apparatus in accordance with claim 13, wherein the cooling section is provided at an upstream side with respect to the thermo compression bonding section in a carrying direction of the card.

15. The card printing apparatus in accordance with claim 13, wherein the cooling section is provided at a downstream side with respect to the thermo compression bonding section in a carrying direction of the card.

16. The card printing apparatus in accordance with claim 15, further comprising:
first carrying means for carrying the card in the carrying direction from the upstream side to the downstream side with respect to the thermo compression bonding section without thermally compression bonding the laminate film on the card by the thermo compression bonding section prior to cooling the card by the cooling section; and
second carrying means for carrying the card in an opposite direction from the downstream side to the upstream side reversed in the carrying direction of the card after cooling the card by the cooling section.

17. The card printing apparatus in accordance with calim 16, further comprising:
third carrying means for carrying the card in the carrying direction from the upstream to the downstream while thermally compression bonding the laminate film on the card by the thermo compression bonding section after the card is carried from the downstream side to the upstream side by the second carrying means.
